(19) United States
(12) Patent Application Publication
(10) Pub. No.: US 2006/0042763 A1
(43) Pub. Date: Mar. 2, 2006

(54) Device for maneuvring a suspended blind

(76) Inventor: Yann Le Ru, Thyez (FR)

Correspondence Address: John Rogitz;Rogitz & Associates, Symphony Towers, 750 B Street Suite 3120, San Diego, CA, 92101, US

(21) Appl. No.: 10/533,897

(22) PCT Filed: Nov. 24, 2003
(86) PCT No.: PCT/IB03/05392

§ 371 Date: May 5, 2005

(30) Foreign Application Priority Data
Nov. 26, 2002 (FR) 02 14822

(51) Int. Cl. E06B 9/30

(52) U.S. Cl. 160/171

(57) ABSTRACT

The invention relates to a blind-manoeuvring device (40) consisting of a drum (42) for winding at least one cord (2, 5) which is connected to the blind and a support (41) for said drum (42). The aforementioned drum support comprises at least two parts (41a, 41b) which are assembled such as to form passage holes (48) in which the cords (2, 5) can slide. The invention is characterised in that each of the aforementioned parts (41a, 41b) supports the drum (42) directly or indirectly. During assembly, one such device facilitates the introduction of cords into the winding drum support and enables said task to be automated.

The present invention relates to a device for operating a blind according to the preamble of claim 1.

An operating device of this kind can be fitted to a Roman, Venetian, Austrian, pleated or other type of blind.

A device for operating a Venetian blind comprising a winding drum carrying a cord connected to the blind and a support for this drum is known from patent U.S. Pat. No. 3,352,349. Auxiliary parts are added to the support to form, by their assembly, passages for the cords to run through. These parts have no other function than to create passages for the cords to run through.

This device may thus be mounted more simply than a device such as that described in application EP 1 087 095.

The object of the invention is to provide an operating device that reduces the above problem and improves on the devices of the prior art. In particular, the invention provides a simple device, made with a minimum of parts, that makes it easier to insert cords into the winding drum mounting and allows this task to be automated.

The device according to the invention is characterized by the characterizing part of claim 1.

Various embodiments of the invention are defined by the dependent claims 2 to 5.

The attached drawing shows, by way of examples, two embodiments of the operating device according to the invention.

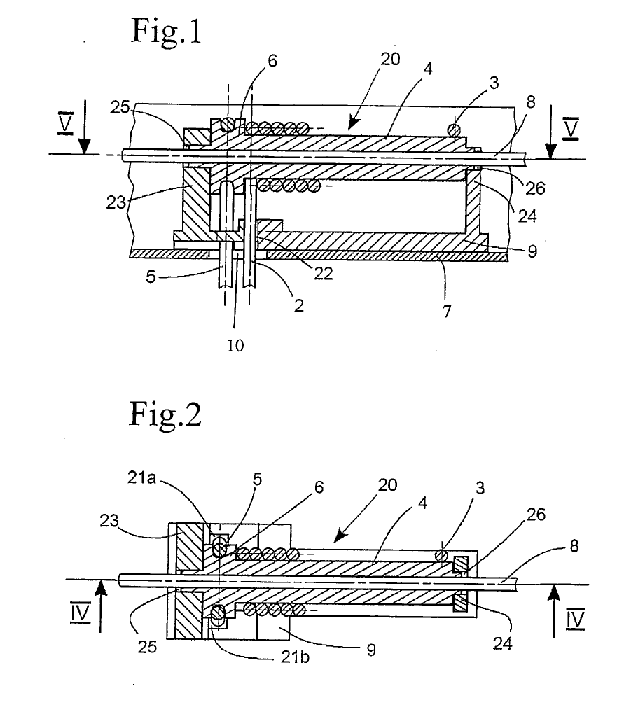

FIG. 1 is a longitudinal cross section on the plane marked IV-IV in FIG. 5 of a first embodiment of the operating device according to the invention.

FIG. 2 is a longitudinal cross section on the plane marked V-V in FIG. 4 of the first embodiment of the operating device according to the invention.

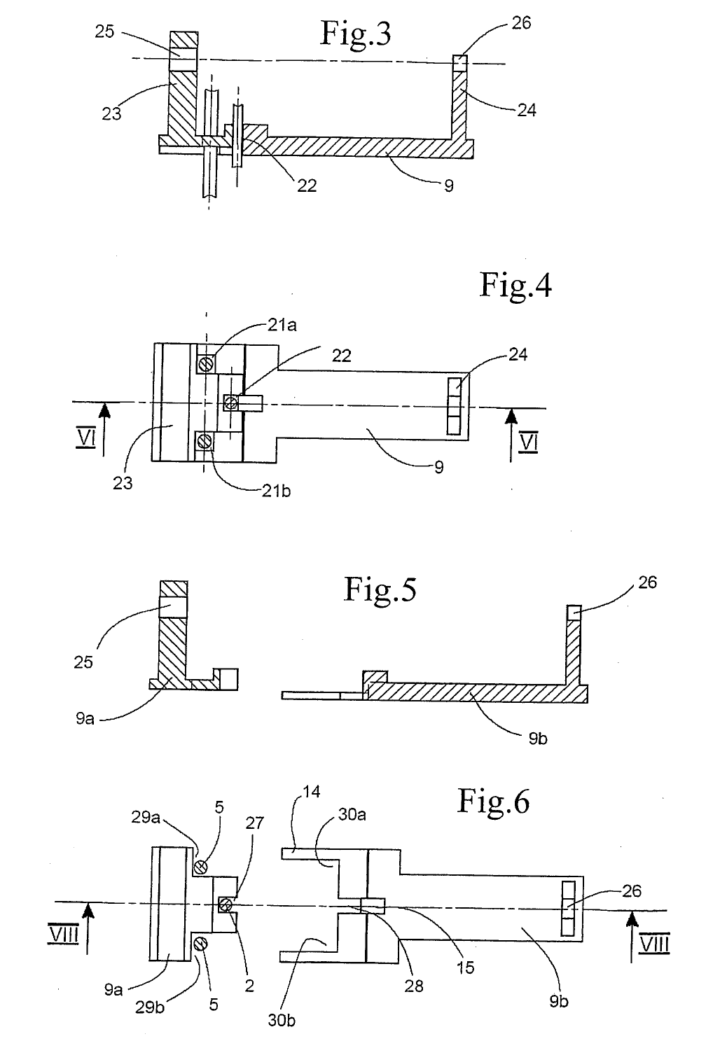

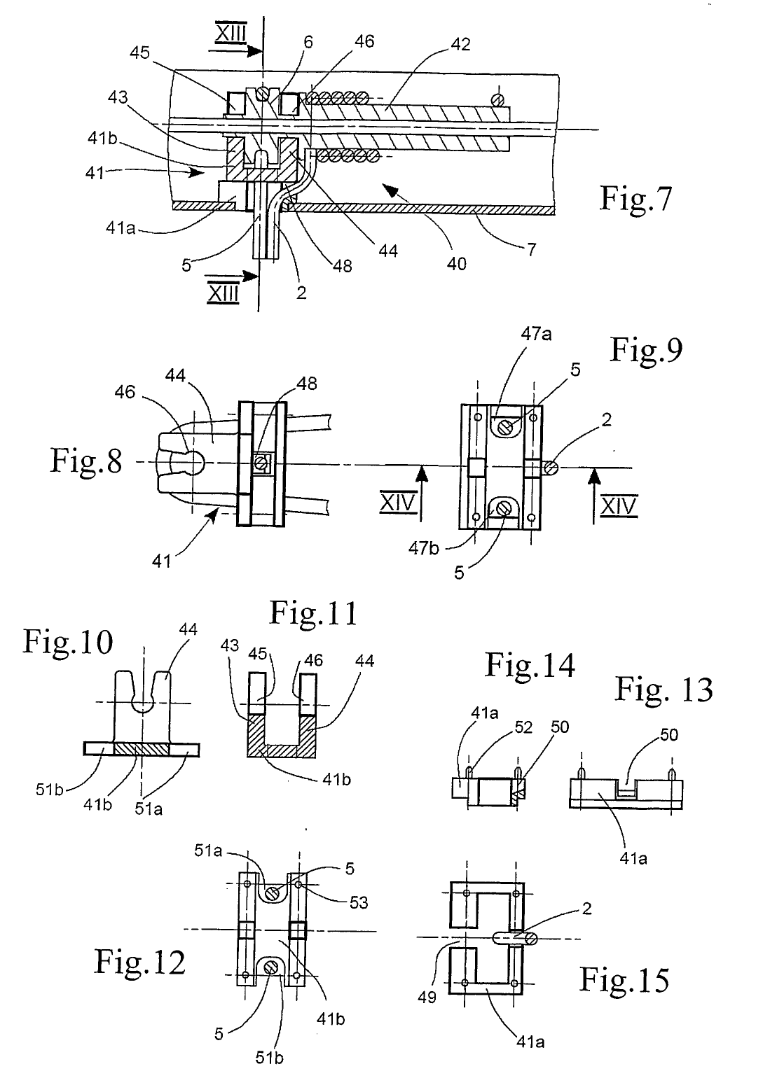

FIG. 3 is a longitudinal cross section on the plane marked VI-VI in FIG. 7 of the mounting of this first embodiment, after its two parts have been assembled.

FIG. 4 is a plan view of the mounting of this first embodiment, after its two parts have been assembled.

FIG. 5 is a longitudinal cross section on the plane marked VIII-VIII in FIG. 9 of the mounting of this first embodiment, before its two parts are assembled.

FIG. 6 is a plan view of the mounting of this first embodiment, before its two parts are assembled.

FIG. 7 is a longitudinal cross section through a second embodiment of the operating device according to the invention.

FIG. 8 is a side view of the mounting of the second embodiment of the operating device, after its two parts have been assembled.

FIG. 9 is a plan view of the mounting of this second embodiment, after its two parts have been assembled.

FIGS. 10 to 12 are views defining the top part of the mounting of the second embodiment of the operating device according to the invention;
FIG. 10 in cross section on the plane marked XIII-XIII in FIG. 7,
FIG. 11 in cross section on the plane marked XIV-XIV in FIG. 9 and
FIG. 12 in a plan view.
FIGS. 13 to 15 are views defining the bottom part of the mounting of the second embodiment of the operating device according to the invention;
FIG. 13 in a side view,
FIG. 14 in cross section on the plane marked XIV-XIV in FIG. 9 and
FIG. 15 in a plan view.

Two operating devices 20 such as that shown in FIGS. 1 and 2 are designed to operate a Venetian blind. Each device 20 comprises a suspension cord 2, one end 3 of which is fixed to a winding drum 4 and the other end to the free end of the blind. It also comprises an angle-setting cord 5 driven by a grooved pulley 6 on the winding drum and connected to each slat of the blind. Thus, by moving the cord 5, the angle of the slats about their longitudinal axes can be set.

This operating device is installed in a headrail 7, having an opening 10 for the cords 2,5 to pass through, fixed to the structure of the building in question. This rail also contains the winding drum 4, a mounting 9 to guide it as it rotates, and a shaft 8 to transmit the motion of a motor/gearbox unit or of a manual device such as a crank to the winding drum. The suspension 2 and angle-setting 5 cords pass through the drum mounting 9 as shown in FIG. 1.

The mounting 9 comprises a baseplate with through holes 21a, 21b for the cord 5 and 22 for the cord 2. Rising from both ends of this baseplate are two lugs 23 and 24. The first lug 23 has a bore 25 and the second has a bore 26 intercepted by a groove. These two lugs support the drum 4, which has a shouldered portion at each end, the diameters of which are equal, to within the working clearance, to the bores 25 and 26 of the lugs. One end of the drum 4 is thus inserted into the bore 25 of the first lug, followed by the other end of the drum being placed in the bore 26 of the second lug by deforming the latter elastically. By these means the drum is guided in rotation on the mounting, which is fixed to the headrail.

The mounting 9 of the winding drum shown in FIGS. 3 and 4 is made in two parts 9a and 9b which are assembled after their cords 2 and 5 have first been positioned relative to both of these parts. The two parts 9a and 9b have cutouts such that they are not exactly complementary. Thus, when they are joined together, holes 21a, 21b and 22 of vertical axes are left between the two parts 9a and 9b for the passage of the cords 2 and 5. In particular, the parts 9a and 9b have two grooves 27, 28 of vertical axes designed to create the passage 22 and two pairs of angles 29a, 30a and 29b, 30b to create the passages 21a and 21b, respectively. The two parts whose shapes are illustrated in FIGS. 5 and 6 can in particular be joined together by engagement by elastic deformation. They can also be bonded or welded. The part 9a, respectively the part 9b, comprises the lug 23, respectively the lug 24. Thus the parts 9a and 9b play a direct role in supporting the drum 4 by the contact actions localized in the area of the bores 25 and 26.

They absorb all the forces exerted on the drum in order to transmit them to the headrail.

The process of assembling such a drum mounting is thus simplified. It may be summarized as involving the following steps:
threading the cords through the holes formed in the headrail,
positioning the cords with respect to the parts of the mounting,
assembling the parts of the mounting,
seating the slat angle-setting cord in the grooved pulley,
fixing the end of the suspension cord to the winding drum,
positioning the winding drum in the mounting, and
installing the resulting assembly in the headrail.

The result of the assembly step is that the cords are held captive in the passages for guiding them.

It should be observed that the steps of positioning the cords relative to the parts of the mounting and joining the parts of the mounting together may occur immediately before the step of positioning the winding drum in the mounting.

A second embodiment of the device according to the invention is shown in FIG. 7. This embodiment relates to a device 40 in which the structure of the mounting 41 of the drum 42 is distinctive. The mounting has two lugs 43 and 44 with two bores 45 and 46 to take the drum 42. The lugs 43 and 44 support the drum either side of the grooved wheel 6 so that the part of the drum on which the cord 2 is to be wound projects cantilever-fashion.

The mounting 41 fixed to a headrail 7 comprises through holes 47a, 47b for the cord 5 and 48 for the cord 2. This mounting 41 shown in FIGS. 8 and 9 is produced in two parts, a lower 41a and an upper 41b. These parts are assembled after the cords 2 and 5 have first been positioned relative to the said parts. These two parts 41a and 41b have shapes such that, once assembled, they define through holes 47a and 47b for the angle-setting cord 5 and one through hole 48 for the suspension cord 2. In particular, the lower part 41a is in the shape of a rectangular ring split by grooves 49 and 50. The upper part 41b has two grooves 51a and 51b of vertical axis. The grooves 51a and 51b combine with the inside of the lower, ring-forming part to produce the passages 47a and 47b. The upper part 41b, once positioned on the lower part 41a, closes the groove 50 to form the through hole 48. The parts 41a and 41b can, just as in the previous case, be joined together by engagement by elastic deformation. To this end, pins 52 can be formed on the upper face of the lower part 41a to fit into holes 53 in the lower face of the upper part 41b. The parts can also be bonded or welded. The part 41a plays a direct role in supporting the drum 42 by direct contact of these lugs 43 and 44 in the area of the bores 45 and 46. The part 41b plays an indirect role in supporting the drum 42, in that it permits a connection between the drum 42 and the headrail via the part 41a. Each part absorbs all the forces exerted on the drum in order to transmit them to the headrail.

This embodiment has the particular advantage of separating the functions performed by the mounting 41. That is to say, on the one hand it is possible to create different lower parts 41a connectable to different types of headrails, and on the other it is possible to create different upper parts 41b connectable to different types of winding drums, any lower part being able to be joined to any upper part. This feature is very important because, rather than manufacture special mountings designed to connect one particular drum to one particular headrail, lower parts specific to the headrails on which they are to be mounted and upper parts specific to the drums they are to receive are produced. The number of different parts the manufacturer has to produce can thus be reduced.

1. Device (20; 40) for operating a blind comprising a winding drum (4; 42) carrying at least one cord (2, 5) connected to the blind and a mounting (9; 41) for this drum (4; 42), produced in at least two parts (9a, 9b; 41a, 41b) which when assembled leave through holes (21a, 21b, 22; 47a, 47b, 48) for the passage of the cords (2, 5), wherein each of these parts (9a, 9b; 41a, 41b) has a direct and/or indirect support function for the drum (4; 42).

2. Operating device (20; 40) according to claim 1, wherein the parts (9a, 9b; 41a, 41b) of the mounting are assembled by non-permanent connections.

3. Operating device (20; 40) according to claim 2, wherein the parts (9a, 9b; 41a, 41b) of the mounting are assembled by means of engagement by elastic deformation

4. Operating device (20; 40) according to claim 1, wherein the parts (9a, 9b) are joined to each other by bringing them together in a direction parallel to the axis of the winding drum (4).

5. Operating device (20; 40) according to claim 1, wherein the parts (41a, 41b) are joined to each other by bringing them together in a direction perpendicular to the axis of the winding drum (42).

6. Operating device (20; 40) according to claim 2, wherein the parts (9a, 9b) are joined to each other by bringing them together in a direction parallel to the axis of the winding drum (4).

7. Operating device (20; 40) according to claim 3, wherein the parts (9a, 9b) are joined to each other by bringing them together in a direction parallel to the axis of the winding drum (4).

8. Operating device (20; 40) according to claim 2, wherein the parts (41a, 41b) are joined to each other by bringing them together in a direction perpendicular to the axis of the winding drum (42).

9. Operating device (20; 40) according to claim 3, wherein the parts (41a, 41b) are joined to each other by bringing them together in a direction perpendicular to the axis of the winding drum (42).
